(19) United States
(12) Patent Application Publication
(10) Pub. No.: US 2010/0192058 A1
(43) Pub. Date: Jul. 29, 2010

(54) PASSIVE ACCESS BY ONLINE ADS TO A LANDING ZONE

(75) Inventor: Brian Rountree, Mountain View, CA (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/359,751

(22) Filed: Jan. 26, 2009

(51) Int. Cl. G06F 3/14

(52) U.S. Cl. 715/246

(57) ABSTRACT

A system and method is described that facilitates the publication of documents, such as Web pages, that include user-viewable elements, such as online advertisements, that automatically expand beyond a region initially allocated to such user-viewable elements in response to certain user input. In an embodiment, ad presentation code and event detection code are included within a document. The ad presentation code, when executed by a client computer, causes an expandable user-viewable element to be presented within a first allocated region of the document. The event detection code, when executed by the client computer, monitors for an occurrence of an event and responsive to detecting the occurrence of the event, obtains additional user-viewable content from the expandable user-viewable element and presents the additional user-viewable content within a second allocated region of the document.

### BACKGROUND OF THE INVENTION

1. Field of the Invention

The present invention generally relates to systems and methods for presenting content, such as advertising content, within the context of a network-accessible document such as a Web page.

2. Background

Online advertising refers to the delivery of advertising content to users via a network, such as the Internet. Such advertising content may be inserted within Web pages, e-mails, or other documents delivered to the users via the network. Online advertising provides a number of advantages as compared to other conventional forms of advertising. These advantages include, among others, the ability to quickly reach a massive and growing global audience of users, the ability to perform highly-targeted and personalized marketing, and the ability to immediately capitalize on user interest by providing a direct link to an advertiser's Web site. Due to advantages such as these, the market for the placement of online advertisements (“ads”) has grown rapidly as more and more companies are setting aside marketing budget for online advertising.

In recent years, sophisticated ad delivery systems have been developed that operate to dynamically insert online ads into network-accessed documents at the time such documents are served to or browsed by users. In accordance with many ad delivery system models, an advertiser or other entity develops an ad and then provides it to an ad server for automated insertion into Web pages published by one or more publishers. The destination Web pages may include, for example, search results pages generated by search engines such as those associated with Yahoo! Inc. of Sunnyvale Calif. and Google Inc. of Mountain View Calif., content aggregation Web pages such as Yahoo! Finance published by Yahoo! Inc., online shopping Web pages, online auction Web pages, social networking Web pages, blogs, or the like.

Various types of online ads exist. One popular type of online ad comprises a rectangular banner or button that is inserted within an allocated region of a Web page.

Depending upon the design, the banner or button ad may comprise a static image, such as a Graphics Interchange Format (GIF), Joint Photographic Experts Group (JPEG) or Portable Network Graphics (PNG) image, and/or a computer program or multimedia object that, when executed by a Web browser, displays an animated image and/or other multimedia content within the allocated region of the Web page. The Web browser may execute the computer program or multimedia object employing technologies such as Sun Microsystems™ Java™, Adobe® Flash®, Adobe® Shockwave®, or Microsoft® Silverlight™.

When an advertiser is responsible for providing an online ad that will be inserted within the body of a publisher Web page, it is important that the online ad be designed in such a way that it integrates well with the Web page. For example, banner or button ads provided by an advertiser must typically conform to certain size requirements so that they do not extend beyond an allocated region of a Web page. When the banner or button ad has been constructed using a computer program or multimedia object as noted above, it is important that such program or object, when executed by a Web browser, execute in a manner that is stable and that will not impair or impede a user's ability to view and interact with other elements on the Web page. Consequently, strict guidelines may be provided to the advertiser and enforced by or on behalf of the publisher to ensure that all ads submitted by advertisers comply with such requirements.

It would be advantageous to provide advertisers with a means by which to expand banner and button ads beyond the traditional rectangular-shaped confines associated with such ads in response to certain user input. The ability to expand online ads in such a manner could provide advertisers with a platform by which to convey additional information to users and to spark increased interest in their ads. Furthermore, Web site publishers could gain access to additional revenue by charging more for hosting such ads. However, there are several challenges associated with providing such functionality. For example, by allowing advertisers to create banner and button ads that are capable of displaying additional content beyond the rectangular boundaries normally associated with such ads (e.g., by manipulating other nodes in the document object model (DOM) representation of the Web page), a publisher risks exposing a Web page to new advertiser-provided code that may not execute in a stable manner or that may impede or impair a user's ability to view and/or interact with other elements on the Web page. Furthermore, the space on a Web page for accommodating ad content may be limited and it thus may be difficult to allow more than one ad served within a Web page to display additional content.

What is needed then is a system and method that allows advertisers to submit for publication online ads that automatically expand beyond a region initially allocated to such ads in response to certain user input. For example, the system and method should allow advertisers to submit for publication banner and button ads that automatically expand to a region or regions beyond a delineated region of a Web page initially allocated to such ads in response to certain user input. The desired system and method should preferably limit exposure by a Web page that hosts such expandable online ads to new advertiser-provided code that may not execute in a stable manner or that may impede or impair a user's ability to view and/or interact with other elements on the Web page. The desired system and method should also preferably allow multiple expandable online ads to be efficiently accommodated within a Web page having limited advertising space.

### BRIEF SUMMARY OF THE INVENTION

A system and method is described herein that facilitates the publication of documents, such as Web pages, that include user-viewable elements, such as online ads, that automatically expand beyond a region initially allocated to such user-viewable elements in response to certain user input. The system and method may advantageously be used, for example, to allow advertisers and other entities to submit for publication ads that automatically expand to a region or regions beyond a delineated region of a Web page initially allocated to such ads in response to certain user input. In an embodiment, the system and method limits exposure by a document that hosts such expandable user-viewable elements to new code developed by third parties that may not execute in a stable manner or that may impede or impair a user's ability to view and/or interact with other elements in the document. An embodiment of the system and method also allow multiples expandable user-viewable elements to be efficiently accommodated within a document having limited space.

In particular, a method for serving a user-viewable document to a user over a network in a manner that facilitates the presentation of at least one expandable user-viewable element within the document is described herein. In accordance with the method, a document is assembled and the assembled document is served to the user over the network. Assembling the document comprises including ad presentation code and event detection code within the document. The ad presentation code, when executed by a client computer, causes a first expandable user-viewable element to be presented within a first allocated region of the document when the document is presented to the user via a display of the client computer, wherein the first expandable user-viewable element includes logic capable of providing first additional user-viewable content. The event detection code, when executed by the client computer, monitors for an occurrence of a first event initiated by the user of the client computer. Responsive to detecting the occurrence of the first event, the event detection code obtains the first additional user-viewable content from the first expandable user-viewable element and presents the first additional user-viewable content within a second allocated region of the document when the document is presented to the user via the display of the client computer.

A system is also described herein. The system is configured to serve a user-viewable document to a user over a network in a manner that facilitates the presentation of at least one expandable user-viewable element within the document. The system includes a document assembler and a document server.

The document assembler is configured to assemble the document by including ad presentation code within the document that, when executed by a client computer, causes a first expandable user-viewable element to be presented within a first allocated region of the document when the document is presented to the user via a display of the client computer. The first expandable user-viewable element includes logic capable of providing first additional user-viewable content.

The document assembler is further configured to assemble the document by including event detection code within the document that, when executed by the client computer, monitors for an occurrence of a first event initiated by the user of the client computer and that, responsive to detecting the occurrence of the first event, obtains the first additional user-viewable content from the first expandable user-viewable element and presents the first additional user-viewable content within a second allocated region of the document when the document is presented to the user via the display of the client computer.

The document server is configured to serve the assembled document to the user over the network.

A method for serving a Web page to a user over a network in a manner that facilitates the presentation of multiple expandable user-viewable elements within the Web page is also described herein. In accordance with the method, the Web page is assembled and the assembled Web page is served to the user over the network. Assembling the Web page comprises including first logic and second logic within the Web page. The first logic, when executed by a client computer, causes a plurality of expandable user-viewable elements to be presented within unique corresponding regions of the Web page when the Web page is presented to the user via a display of the client computer, wherein each of the plurality of expandable user-viewable elements includes logic capable of providing corresponding additional user-viewable content. The second logic, when executed by the client computer, monitors for a user interaction with any of the expandable user-viewable elements. Responsive to detecting a user interaction with a particular one of the expandable user-viewable elements, the second logic obtains the corresponding additional user-viewable content from the particular one of the expandable user-viewable elements and presents the obtained additional user-viewable content within at least one allocated region of the Web page when the Web page is presented to the user via the display of the client computer.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a system for serving expandable online ads to a user in accordance with an embodiment of the present invention.

FIG. 2 depicts a document presented to a display of a client computer that includes an expandable online ad in accordance with an embodiment of the present invention.

FIG. 3 is a block diagram that shows elements of an expandable online ad in accordance with an embodiment of the present invention.

FIG. 4 depicts a document presented to a display of a client computer that includes an expandable online ad and additional ad content associated therewith in accordance with an embodiment of the present invention.

FIG. 5 is a block diagram that shows code components of a document that facilitates the presentation of multiple expandable online ads to a user in accordance with an embodiment of the present invention.

FIG. 6 depicts a document presented to a display of a client computer that includes multiple expandable online ads in accordance with an embodiment of the present invention.

FIGS. 7 and 8 each depict a document presented to a display of a client computer that includes multiple expandable online ads and additional ad content associated with one such ad in accordance with an embodiment of the present invention.

FIG. 9 depicts a document presented to a display of a client computer that includes multiple expandable online ads and multiple regions for displaying additional ad content associated with each such ad in accordance with an embodiment of the present invention.

FIG. 10 is a block diagram depicting the contents of a document that may be served by document serving system in accordance with an embodiment of the present invention.

FIG. 11 illustrates the delivery of an Adobe® Flash® component from a document publisher system to an ad development environment associated with an advertiser or other third-party entity in accordance with an embodiment of the present invention.

FIG. 12 depicts a flowchart of a method for serving a user-viewable document to a user over a network in a manner that facilitates the presentation of at least one expandable user-viewable element in accordance with an embodiment of the present invention.

FIG. 13 depicts a flowchart of a method for performing the step of assembling a document set forth in the flowchart of FIG. 12.

FIG. 14 depicts a flowchart of a method for executing ad presentation logic within a document by a document browser in accordance with an embodiment of the present invention.

FIG. 15 depicts a flowchart of a method for executing event detection logic within a document by a document browser in accordance with an embodiment of the present invention.

FIG. 16 is a block diagram of an example computer system that may be used to implement aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

### II. Example System for Serving of Expandable Online Ads

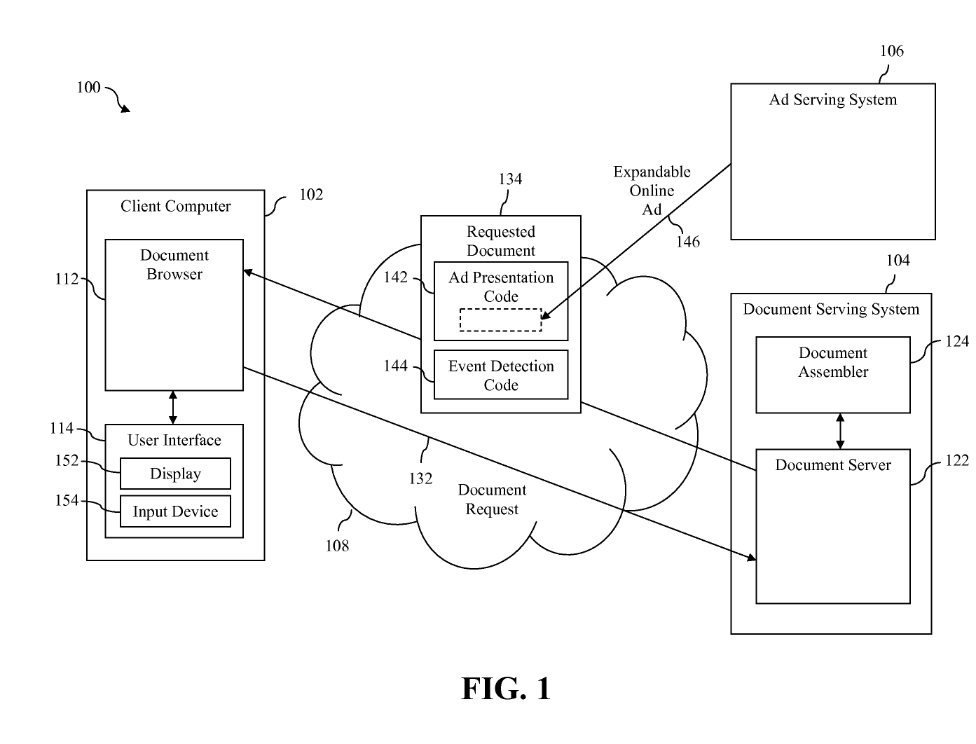

FIG. 1 is a high-level block diagram of an exemplary system 100 for serving expandable online ads to a user in accordance with an embodiment of the present invention. As shown in FIG. 1, system 100 includes a client computer 102, a document serving system 104, and an ad serving system 106. Each of these components is communicatively connected to a network 108. In an embodiment, network 108 comprises a wide area network such as the Internet. However, the invention is not so limited and network 108 may comprise any type of network or combination of networks including wide area networks, local area networks, personal area networks, private networks, public networks, packet networks, and circuit-switched networks. Each network included within network 108 may be implemented over wired and/or wireless communication mediums.

Client computer 102 includes a document browser 112 and a user interface 114. Document browser 112 comprises logic that is configured to access remote servers over network 108 for the purpose of retrieving user-viewable documents and presenting such documents to a user via user interface 114. User interface 114 includes at least a display 152 by which a user may view such documents and an input device 154 for allowing the user to selectively retrieve the user-viewable documents and optionally interact with elements displayed within such documents. Input device 154 may comprise, for example, a mouse or other pointing device, a keyboard, keypad, touch screen, or the like.

In an embodiment, document browser 112 comprises a software-implemented Web browser that is executed by one or more processors or processor cores within client computer 102 and the documents retrieved over network 108 comprise Web pages. The Web browser may comprise, for example, any commercially-available or publicly-available Web browser, including but not limited to Internet Explorer (published by Microsoft Corporation of Redmond, Wash.), Mozilla® Firefox® (published by Mozilla Corporation of Mountain View, Calif.), or Safari® (published by Apple Computer of Cupertino, Calif.). However, these are examples only and are not intended to be limiting. In accordance with such an implementation, client computer 102 may comprise any system or device that is capable of executing a Web browser. For example, client computer 102 may comprise a desktop computer, laptop computer, tablet computer, gaming console, personal digital assistant, cellular telephone, portable media player or the like.

Document serving system 104 comprises a system configured to publish documents for retrieval by client computers, such as client computer 102, via network 108. As noted above, in one embodiment, the documents published by document serving system may comprise Web pages, although the invention is not so limited.

As will be appreciated by persons skilled in the relevant art(s), any of a wide variety of entities may own and/or operate document serving system 104. In one embodiment, a content aggregator, such as Yahoo! Inc. of Sunnyvale Calif., owns and operates document serving system 104 for the purpose of publishing Web pages that include various types of information that may be of interest to users. For example, the Web pages served by document serving system 104 may comprise Web pages associated with a Web site that is dedicated to providing finance-related information (e.g., Yahoo! Finance) although this is merely one example.

Document serving system 104 includes a document server 122 and a document assembler 124. Document server 122 is configured to receive requests for documents from document browsers executing on client computers, such as document browser 112 executing on client computer 102, and to pass information about such requests to document assembler 124 to which it is communicatively connected. Document assembler 124 is configured to dynamically assemble requested documents responsive to receiving such information from document server 122 and to provide the assembled documents to document server 122 for transmission to the appropriate client computer over network 108. By way of example, in FIG. 1, the transmission of a document request 132 from document browser 112 to document server 122 and the responsive transmission of a requested document 134 from document server 122 to document browser 112 is shown.

In an embodiment, each of document server 122 and document assembler 124 comprises a software program or collection of software programs executing on a computer. Depending upon the implementation, document server 122 and document assembler 124 may be executed on the same computer or on different interconnected computers.

Ad serving system 106 comprises an automated system that is configured to provide online ads for inclusion within documents served by document serving system 104, wherein such online ads may include one or more expandable online ads in accordance with an embodiment of the present invention. Ad serving system 106 may be owned and/or operated by the same entity that owns and/or operates document serving system 104 or by some other entity, such as an advertiser or third-party ad serving company. In an embodiment, ad serving system 106 provides an interface by which an advertiser may create or otherwise submit such expandable online ads.

Depending upon the implementation, different methods may be used to include an expandable online ad provided by ad serving system 106 within a document served by document serving system 104. For example, in accordance with a first method, ad serving system 106 provides an expandable online ad to document assembler 124 within document serving system 104 and document assembler 124 includes the expandable online ad within a document at the time the document is assembled. In accordance with a second method, document assembler 124 inserts a link to an expandable online ad within a document during assembly and the link is executed at the time the document is viewed using a document browser. Upon execution of the link, the expandable online ad is retrieved from ad serving system 106 over network 108 and loaded into the document at the document browser.

The manner in which an expandable online ad may be presented within a document served by document serving system 104 will now be further explained in reference to requested document 134. As shown in FIG. 1, requested document 134 includes at least ad presentation code 142 and event detection code 144. Ad presentation code 142 and event detection code 144 each comprise elements of requested document 134 that will be executed by document browser 112 when document browser 112 presents requested document 134 to display 152 of client computer 102. Ad presentation code 142 and event detection code 144 are each included within requested document 134 by document assembler 124.

When executed by document browser 112, ad presentation code 142 causes an expandable online ad 146 to be presented within a first allocated region of document 134 when the document is presented to the user via display 152. In an embodiment in which document assembler 124 loads expandable online ads at the time of document assembly, ad presentation code 142 includes expandable online ad 146. In an embodiment in which document browser 112 loads expandable online ads at the time the document is browsed, ad presentation code 142 comprises code that, when executed by document browser 112, obtains expandable online ad 146 from a remote server, such as a server within ad serving system 106.

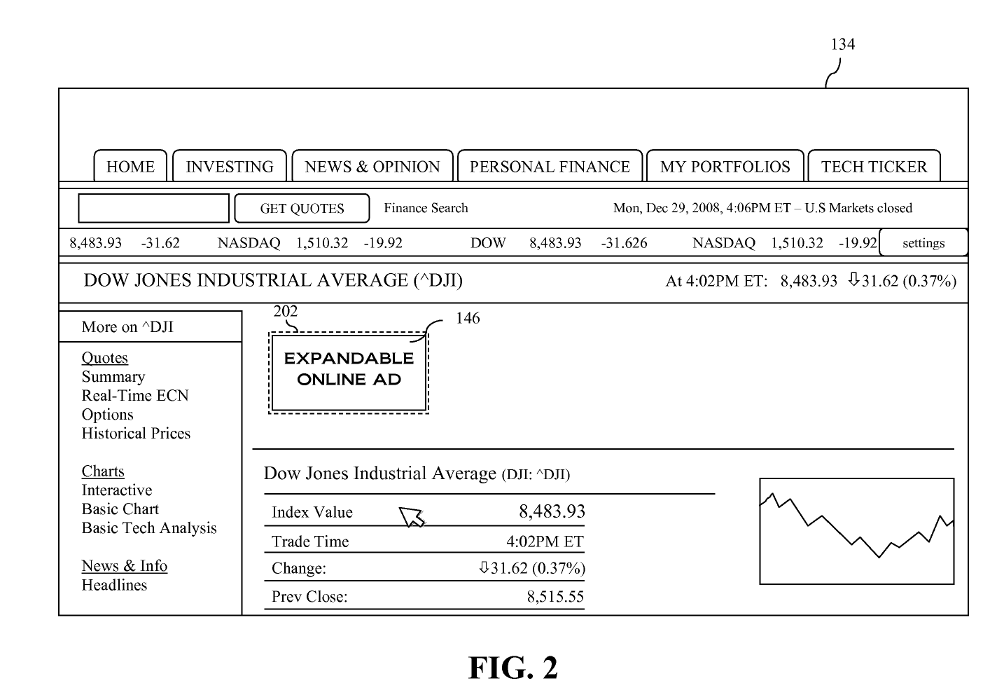

By way of example, FIG. 2 illustrates the presentation of expandable online ad 146 within a first allocated region 202 of document 134 when document 134 is presented to display 152 of client computer 102. In accordance with the example shown in FIG. 2, expandable online ad 146 is initially presented as a button ad that is displayed within an allocated rectangular region 202 of document 134. However, this is an example only and expandable online ad 146 may initially be presented in a first allocated region having other shapes and dimensions than that shown in FIG. 2.

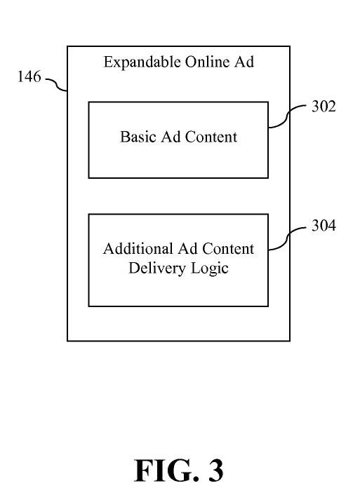

As shown in FIG. 3, expandable online ad 146 comprises basic ad content 302 that is to be displayed within first allocated region 202. Depending upon the implementation, this ad content may comprise a static image, an animation, and/or multimedia content such as video content. When the ad content comprises an animation and/or multimedia content, document browser 112 may utilize a “plug-in” software module in order to present the advertising content. Such plug-in software modules may include for example a Java™ plug-in made available by Sun Microsystems™ of Santa Clara, Calif., an Adobe® Flash® or Shockwave® plug-in made available by Adobe Systems Inc. of San Jose, Calif., or a Microsoft® Silverlight™ plug-in made available by Microsoft Corporation of Redmond, Wash. For the purposes of this application, such “plug-in” modules are considered an integrated part of document browser 112. The ad content may also comprise one or more interactive elements such as hyperlinks.

As also shown in FIG. 3, expandable online ad 146 further includes additional ad content delivery logic 304 that is capable of delivering additional ad content for display within a second allocated region of document 134. Depending upon the implementation, this additional ad content may be embedded within expandable online ad 146 at the time expandable online ad 146 is loaded within document 134 or may be subsequently retrieved from a remote entity, such as a server within ad serving system 106.

Event detection code 144 comprises code within document 134 that, when executed by document browser 112, monitors for occurrence of an event that is initiated by the user of client computer 102 using input device 154. In an embodiment, the event comprises the hovering of an on-screen pointer over the first allocated region initially occupied by expandable online ad 146 when presented to display 152. Responsive to detecting the occurrence of the event, event detection code 144 obtains the additional ad content from additional ad content delivery logic 304 within expandable online ad 146 and presents the additional ad content within a second allocated region of document 134 when document 134 is presented to display 152 of client computer 102.

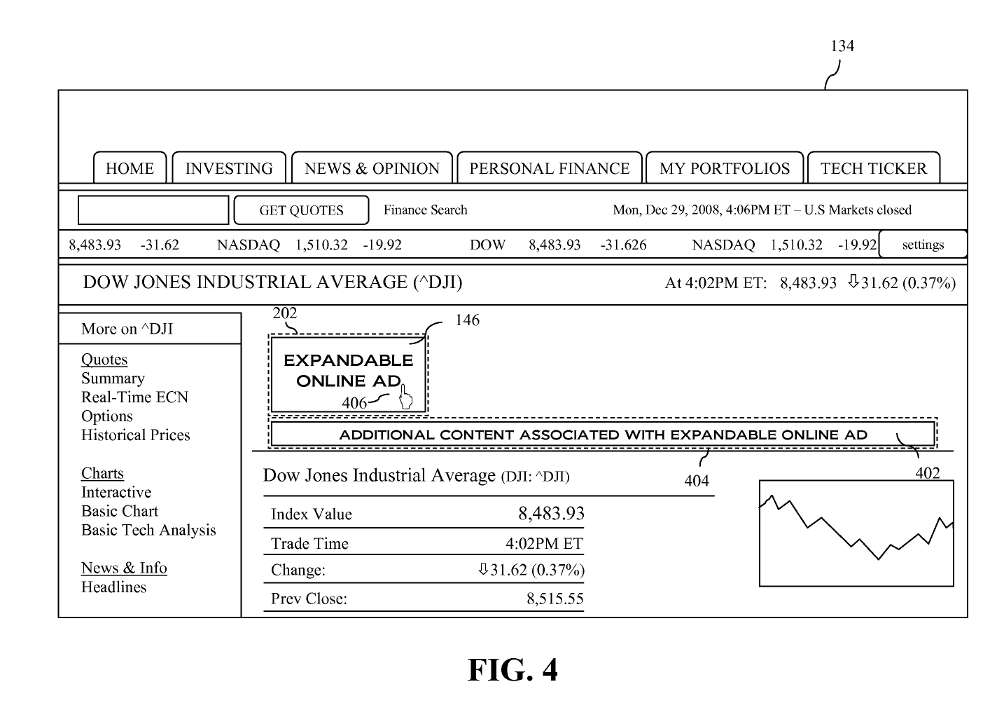

By way of example, FIG. 4 depicts the appearance of document 134 as presented to display 152 of client computer 102 after a user has hovered an on-screen pointer 406 over first allocated region 202. As shown in FIG. 4, responsive to the hovering of on-screen pointer 406 over first allocated region 202, event detection code 144 has obtained additional ad content 402 from logic 304 within expandable online ad 146 and presented said additional ad content 402 within a second allocated region 404 of document 134.

As noted above, in one embodiment, additional ad content 402 is embedded within expandable online ad 146 at the time expandable online ad 146 is loaded by document browser 112. In such an embodiment, the foregoing technique advantageously permits a user to easily and selectively obtain additional information or content corresponding to expandable online ad 146 in a manner that does not require new ad content to be retrieved from a server or other remote network entity. This can help to improve the performance of document browser 112 and to conserve the amount of network bandwidth consumed by that logic. From the perspective of the entity serving the ad content (e.g., ad serving system 106 or document serving system 104 in certain implementations), this approach can result in a significantly reduced number of ad content requests.

As also noted above, in another embodiment, additional ad content 402 is retrieved by additional ad content delivery logic 304 from a remote network entity, such as a server within ad serving system 106. Such an embodiment advantageously permits an advertiser or other entity to update or otherwise modify additional ad content 402 at any time without having to modify expandable online ad 146 itself. For example, an advertiser may wish to modify a message conveyed by additional ad content 146 to quickly react to changing market conditions. Such an embodiment also allows expandable online ad 146 to be implemented using a smaller file size since the additional ad content 146 need not be embedded within ad 146.

In either case, as will be discussed in more detail below, since expandable online ad 146 may be provided by an advertiser and event detection code 144 may be provided by a publisher of document 134, the foregoing approach advantageously allows the publisher, rather than the advertiser, to manage the presentation of the additional ad content within document 134. Consequently, the publisher of document 134 can ensure that such logic executes in a stable manner and that the additional ad content is presented in a manner that will not impair or impede a user's ability to view and interact with other elements within document 134. Additionally, by controlling the manner in which such content is presented, the publisher can offer the advertiser with a variety of presentation options (e.g., fade in/fade out, animations, style effects, timers, click-to-close, etc.), thereby creating potential monetization options for the publisher.

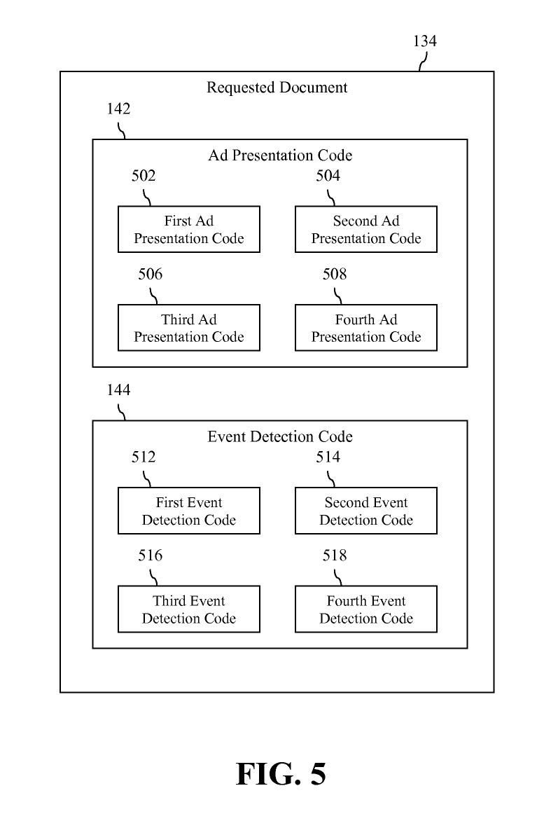

Although the foregoing describes the presentation of a single expandable online ad within document 134, it is to be understood that an embodiment of the present invention facilitates the presentation of multiple expandable online ads within a document. For example, in one example embodiment, four multiple expandable online ads may be presented within document 134. A representation of document 134 in accordance with such an embodiment is depicted in FIG. 5.

As shown in FIG. 5, ad presentation code 142 within document 134 includes four sub-components: first ad presentation code 502, second ad presentation code 504, third ad presentation code 506 and fourth ad presentation code 508. When executed by document browser 112, first ad presentation code 502 causes a first expandable online ad to be presented within a first allocated region of document 134 when the document is presented to the user via display 152, second ad presentation code 504 causes a second expandable online ad to be presented within a second allocated region of document 134 when the document is presented to the user via display 152, third ad presentation code 506 causes a third expandable online ad to be presented within a third allocated region of document 134 when the document is presented to the user via display 152, and fourth ad presentation code 508 causes a fourth expandable online ad to be presented within a fourth allocated region of document 134 when the document is presented to the user via display 152.

In an embodiment in which document assembler 124 loads expandable online ads at the time of document assembly, each of first ad presentation code 502, second ad presentation code 504, third ad presentation code 506 and fourth ad presentation code 508 includes a corresponding expandable online ad. In an embodiment in which document browser 112 loads expandable online ads at the time the document is browsed, each of first ad presentation code 502, second ad presentation code 504, third ad presentation code 506 and fourth ad presentation code 508 comprises code that, when executed by document browser 112, obtains a corresponding expandable online ad from a remote server, such as a server within ad serving system 106.

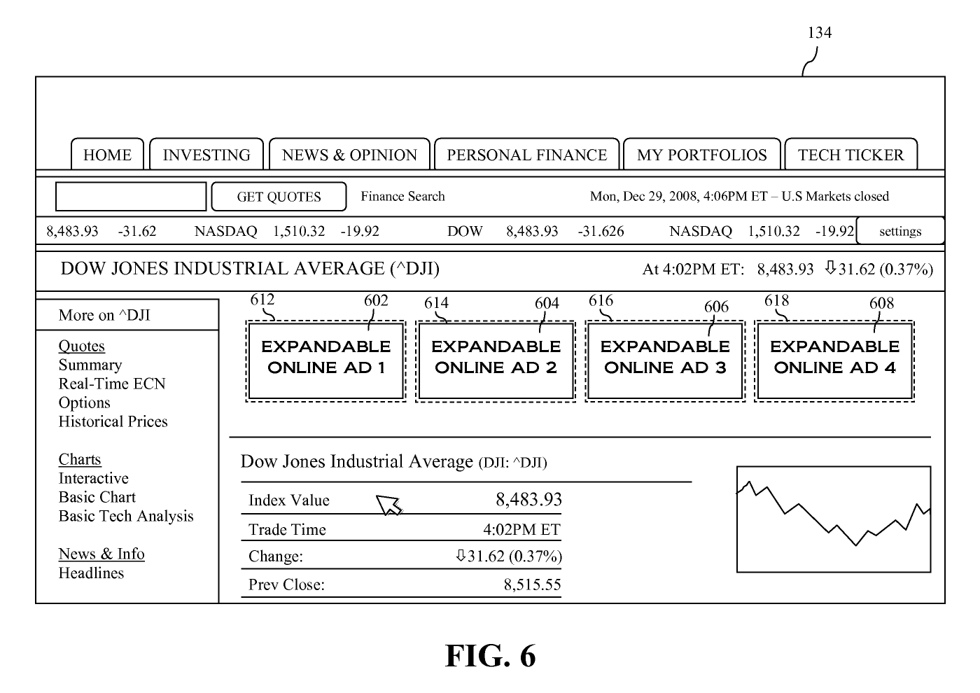

By way of example, FIG. 6 illustrates the presentation of a first expandable online ad 602 within a first allocated region 612 of document 134, the presentation of a second expandable online ad 604 within a second allocated region 614 of document 134, the presentation of a third expandable online ad 606 within a third allocated region 616 of document 134 and the presentation of a fourth expandable online ad 608 within a fourth allocated region 618 of document 134 when document 134 is presented to display 152 of client computer 102. In accordance with the example shown in FIG. 6, each of the four expandable online ads is initially presented as a button ad that is displayed within a corresponding allocated rectangular region of document 134. However, this is an example only and the expandable online ads may initially be presented in allocated regions having other shapes and dimensions than that shown in FIG. 6.

Like expandable online ad 146 discussed above in reference to FIGS. 1-4, each of first expandable online ad 602, second expandable online ad 604, third expandable online ad 606 and fourth expandable online ad 608 includes basic ad content that is to be displayed within a corresponding one of first allocated region 612, second allocated region 614, third allocated region 616 and fourth allocated region 618. Each of these expandable online ads further includes corresponding additional ad content delivery logic that is capable of delivering additional ad content for display within a fifth allocated region of document 134 as will be discussed in more detail below.

As further shown in FIG. 5, event detection code 144 within document 134 includes four sub-components: first event detection code 512, second event detection code 514, third event detection code 516 and fourth event detection code 518.

First event detection code 512 comprises code within document 134 that, when executed by document browser 112, monitors for occurrence of a first event that is initiated by the user of client computer 102 using input device 154. In an embodiment, the first event comprises the hovering of an on-screen pointer over the first allocated region (e.g., first allocated region 612) initially occupied by the first expandable online ad (e.g., first expandable online ad 602) when presented to display 152. Responsive to detecting the occurrence of the first event, first event detection code 512 obtains additional ad content from logic within the first expandable online ad and presents the additional ad content within a fifth allocated region of document 134 when document 134 is presented to display 152 of client computer 102. Second event detection code 514 comprises code within document 134 that, when executed by document browser 112, monitors for occurrence of a second event that is initiated by the user of client computer 102 using input device 154. In an embodiment, the second event comprises the hovering of an on-screen pointer over the second allocated region (e.g., second allocated region 614) initially occupied by the second expandable online ad (e.g., second expandable online ad 604) when presented to display 152. Responsive to detecting the occurrence of the second event, second event detection code 514 obtains additional ad content from logic within the second expandable online ad and presents the additional ad content within the fifth allocated region of document 134 when document 134 is presented to display 152 of client computer 102.

Third event detection code 516 comprises code within document 134 that, when executed by document browser 112, monitors for occurrence of a third event that is initiated by the user of client computer 102 using input device 154. In an embodiment, the third event comprises the hovering of an on-screen pointer over the third allocated region (e.g., third allocated region 616) initially occupied by the third expandable online ad (e.g., third expandable online ad 606) when presented to display 152. Responsive to detecting the occurrence of the third event, third event detection code 516 obtains additional ad content from logic within the third expandable online ad and presents the additional ad content within the fifth allocated region of document 134 when document 134 is presented to display 152 of client computer 102.

Fourth event detection code 518 comprises code within document 134 that, when executed by document browser 112, monitors for occurrence of a fourth event that is initiated by the user of client computer 102 using input device 154. In an embodiment, the fourth event comprises the hovering of an on-screen pointer over the fourth allocated region (e.g., fourth allocated region 618) initially occupied by the fourth expandable online ad (e.g., fourth expandable online ad 608) when presented to display 152. Responsive to detecting the occurrence of the fourth event, fourth event detection code 518 obtains additional ad content from logic within the fourth expandable online ad and presents the additional ad content within the fifth allocated region of document 134 when document 134 is presented to display 152 of client computer 102.

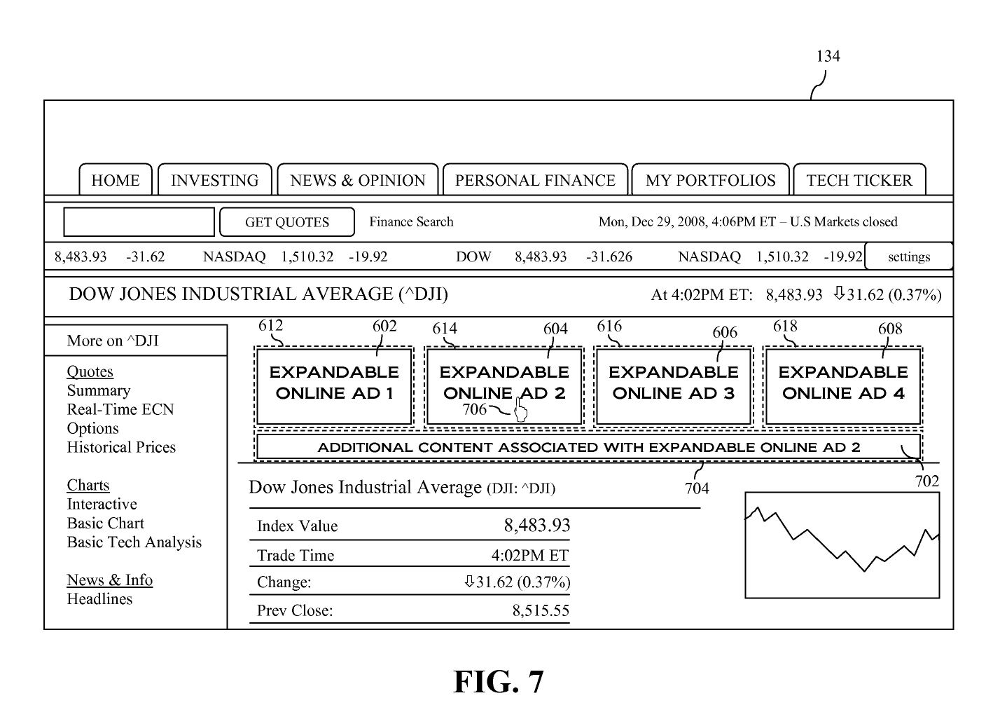

To help illustrate the operation of some of the foregoing sub-components of event detection code 144, FIG. 7 depicts the appearance of document 134 as presented to display 152 of client computer 102 after a user has hovered an on-screen pointer 706 over second allocated region 614. As shown in FIG. 7, responsive to the hovering of on-screen pointer 706 over second allocated region 614, second event detection code 514 has obtained additional ad content 702 from logic within second expandable online ad 604 and presented said additional ad content 702 within a fifth allocated region 704 of document 134.

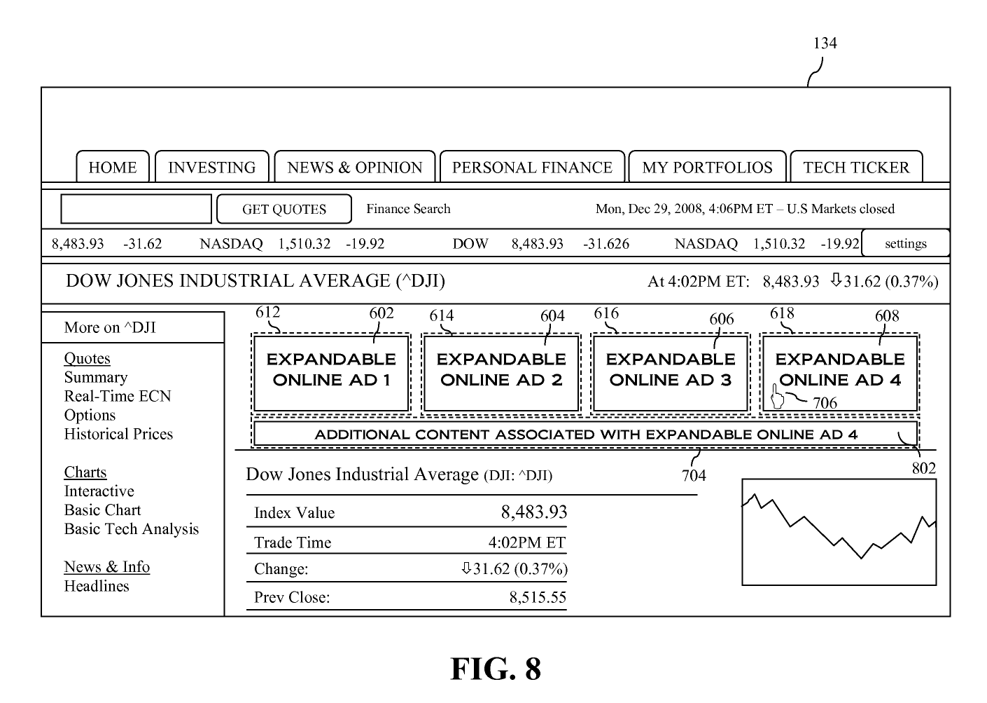

Continuing with this example, FIG. 8 depicts the appearance of document 134 as presented to display 152 of client computer 102 after a user has hovered on-screen pointer 706 over fourth allocated region 618. As shown in FIG. 8, responsive to the hovering of on-screen pointer 706 over fourth allocated region 618, fourth event detection code 518 has obtained additional ad content 802 from logic within fourth expandable online ad 608 and presented said additional ad content 802 within fifth allocated region of 704 of document 134.

In the foregoing example, event detection code 144 can obtain additional ad content from each of the four expandable online ads and present the content within the same allocated region 704 of document 134 when document 134 is presented to display 152. Allocated region 704 may thus be thought of as a shared “landing zone” for each of the expandable online ads. In an embodiment in which additional ad content is obtained from an expandable online ad when a user hovers an on-screen pointer over the ad, only a single expandable online ad may use the landing zone at a time, since only a single expandable online ad may be hovered over at a single point in time. The use of such a shared landing zone is particularly advantageous if space on document 134 is limited, since it allows multiple expandable online ads to be efficiently accommodated within document 134.

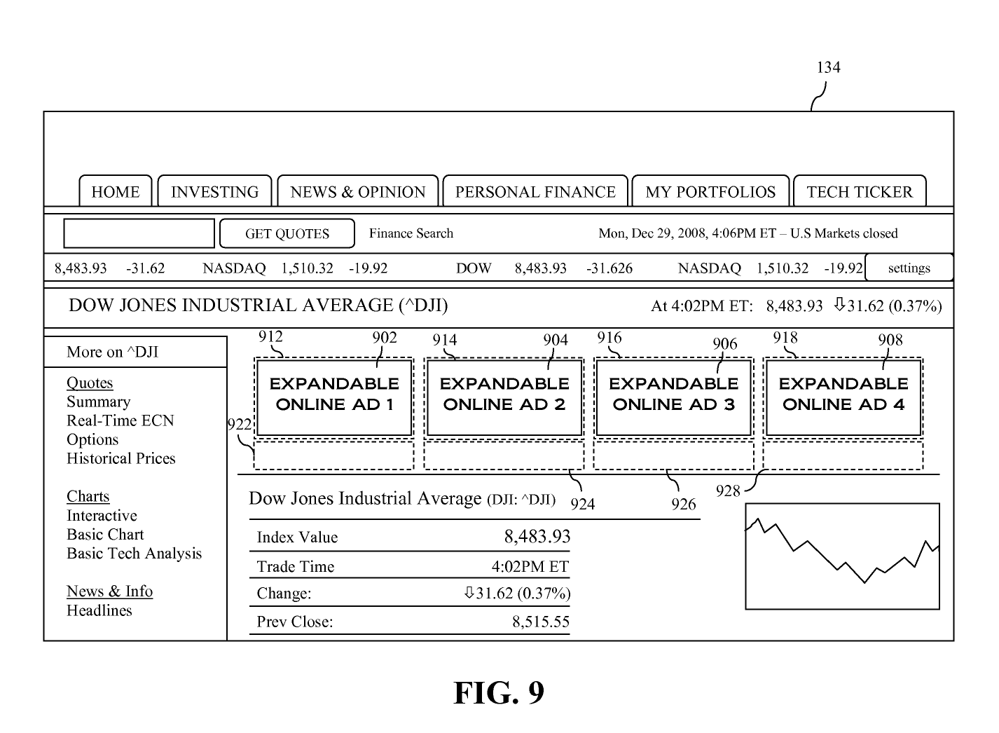

However, an embodiment of the present invention need not utilize a shared landing zone for accommodating additional ad content associated with multiple expandable online ads. For example, FIG. 9 depicts an embodiment in which document 134 includes four expandable online ads 902, 904, 906 and 908 that are displayed in four corresponding allocated regions 912, 914, 916 and 918, each of which facilitates the display of additional ad content in a corresponding allocated region 922, 924, 926 and 928. Thus, in this embodiment, each expandable online ad has its own unique landing zone. Such an embodiment could allow for the simultaneous display of additional ad content associated with multiple expandable online ads.

It should also be noted that although additional ad content in the foregoing embodiments is displayed adjacent to the expandable online ad from which such content was obtained, that need not be the case. For example, additional online ad content associated with an expandable online ad may be displayed in region of document 134 that is relatively removed from the expandable online ad (e.g., the expandable online ad may be displayed at the top of the visible portion of document 134 while the additional ad content associated with the expandable online ad may be displayed at the bottom of the visible portion of document 134).

### III. Communication Between Event Detection Logic and Expandable Online Ad

As described above, event detection code embedded within a document served by document serving system 104 is configured to obtain additional ad content from one or more expandable online ads loaded with the document. In an embodiment, a standardized communication interface is used for communication between the event detection logic and the additional ad content delivery logic embedded in each ad. The standardized communication interface is implemented through the insertion of standardized communication elements in the event detection logic and the additional ad content delivery logic in each ad.

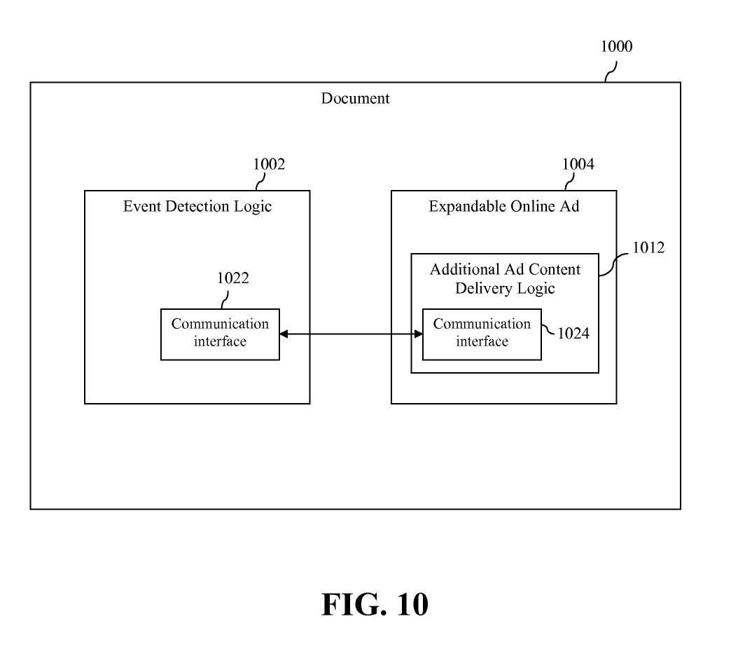

An example of this is depicted in FIG. 10, which shows an example document 1000 that may be served by document serving system 104 in accordance with an embodiment of the present invention. Example document 1000 includes event detection logic 1002 and an expandable online ad 1004 that includes additional ad content delivery logic 1012. Event detection logic 1002 includes a first standardized communication interface 1022 that is used to request the delivery of additional ad content from additional ad content delivery logic 1012. Additional ad content delivery logic 1012 includes a second standardized communication interface 1024 that is used to receive requests for the delivery of additional ad content from event detection logic 1002 and to provide the requested additional ad content to event detection logic 1002 responsive to receiving the request. As noted above, depending upon the implementation, the requested additional ad content may be embedded within expandable online ad 1004 or retrieved from a remote network entity responsive to receiving the request.

The use of a standardized communication interface is particularly advantageous in an embodiment of system 100 in which entities other than the document publisher, such as advertisers, are responsible for developing expandable online ads. In such a scenario, it is important that ads developed by such entities each include additional ad content delivery logic that is capable of functioning in an integrated fashion with the event detection logic embedded within published documents.

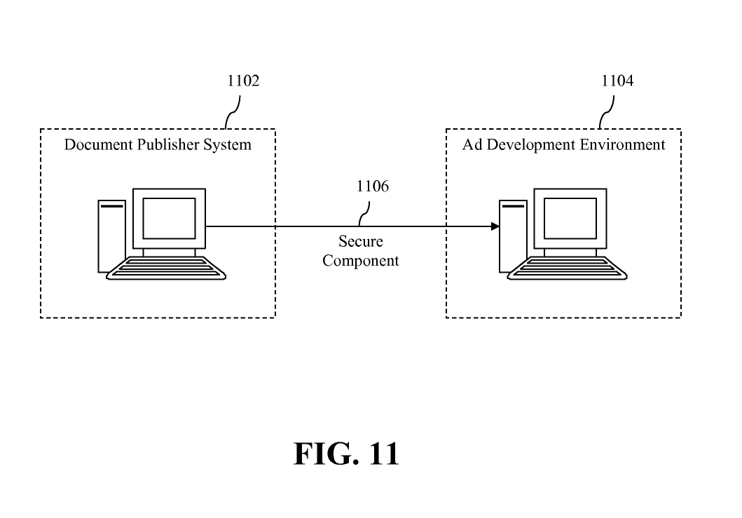

In one embodiment, this issue is addressed through the provision of logic from a document publisher to entities developing expandable online ads, wherein such logic can be used by those entities to implement expandable online ads that include the appropriate standardized communication interface. In an embodiment in which the expandable online ads are developed using Adobe® Flash® technology, this logic may comprise a Flash® component that is provided from the document publisher to advertisers or other third-party entities developing the ads. Such an embodiment is depicted in FIG. 11, which shows the delivery of a Flash® component 1106 from a document publisher system 1102 to an ad development environment 1104 associated with an advertiser or other third-party entity.

For example, in one embodiment, the expandable online ad comprises a Flash® movie executable by a Flash® player and embodied in a .SWF file. During development of the Flash® movie, the ad developer adds component 1106 to the Flash® movie. For example, the ad developer may add component 1106 to a layer of the Flash® movie. Component 1106 may comprise ActionScript 3.0 code configured to listen for a JavaScript function call from event detection logic within a published document and to return additional ad content responsive to receipt of the JavaScript function call. In an embodiment in which the additional ad content is embedded within the expandable online ad, component 1106 may be configured to prompt an ad developer for the additional ad content when the ad developer adds the component to the Flash® movie. For example, where the additional ad content comprises text, component 1106 may be configured to prompt an ad developer for such text when the ad developer adds the component to the Flash® movie. Depending upon the implementation, the publisher may implement component 1106 as a secure Flash® component so that the logic embodied by the component is not exposed to or accessible by the ad developer.

In further accordance with such an embodiment, event detection logic embedded within a document comprises an event listener that detects the occurrence of a particular user-initiated event, such as the hovering of an on-screen pointer over an expandable online ad within the document. Responsive to detecting the event, the event listener within the event detection logic places a JavaScript function call to component 1106 within the expandable online ad. In an embodiment, the function call is implemented using the ActionScript 3.0 externalInterface class. Responsive to receiving the function call, component 1106 returns an object that includes additional ad content associated with the expandable online ad. Depending upon the implementation, the object may be returned as an argument of an executable JavaScript callback function.

The foregoing description is provided by way of example only and persons skilled in the relevant art(s) will readily appreciate that a wide variety of techniques may be used to effect communication between event detection logic and additional ad content delivery logic within an expandable online ad in accordance with embodiments of the present invention.

### IV. Example Method for Serving of Expandable Online Ads

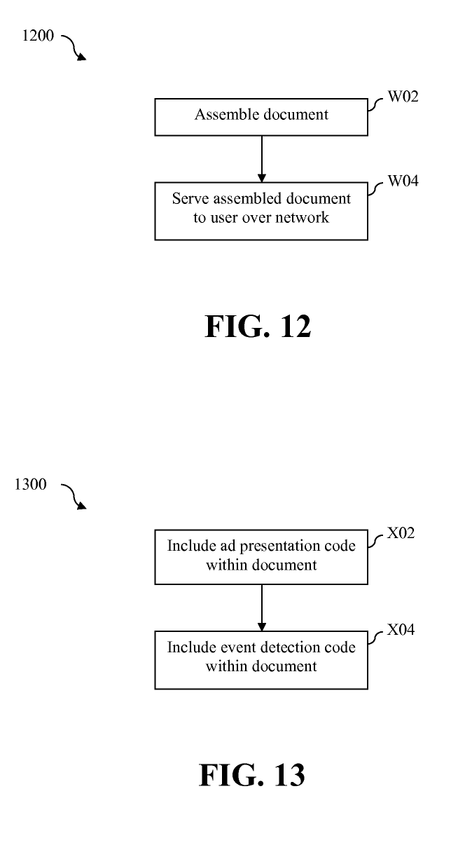

FIG. 12 depicts a flowchart 1200 of an example method for serving user-viewable documents to users over a network in a manner that facilitates the presentation of one or more expandable online ads or other expandable user-viewable elements within such documents. The method of flowchart 1200 will now be described with continued reference to system 100 of FIG. 1, although the method is not limited to that implementation.

As shown in FIG. 12, the method of flowchart 1200 begins at step 1202, in which document assembler 124 within document serving system 104 assembles a document. In an embodiment, the document comprises a Web page. At step 1204, document server 122 serves the assembled document to a user of client computer 102 over network 108.

FIG. 13 depicts a flowchart 1300 of one method for performing step 1202 of flowchart 1200 in accordance with an embodiment of the present invention. As shown in FIG. 13, the method of flowchart 1300 begins at step 1302, in which document assembler 124 includes ad presentation code within the document. At step 1304, document assembler 124 includes event detection code within the document.

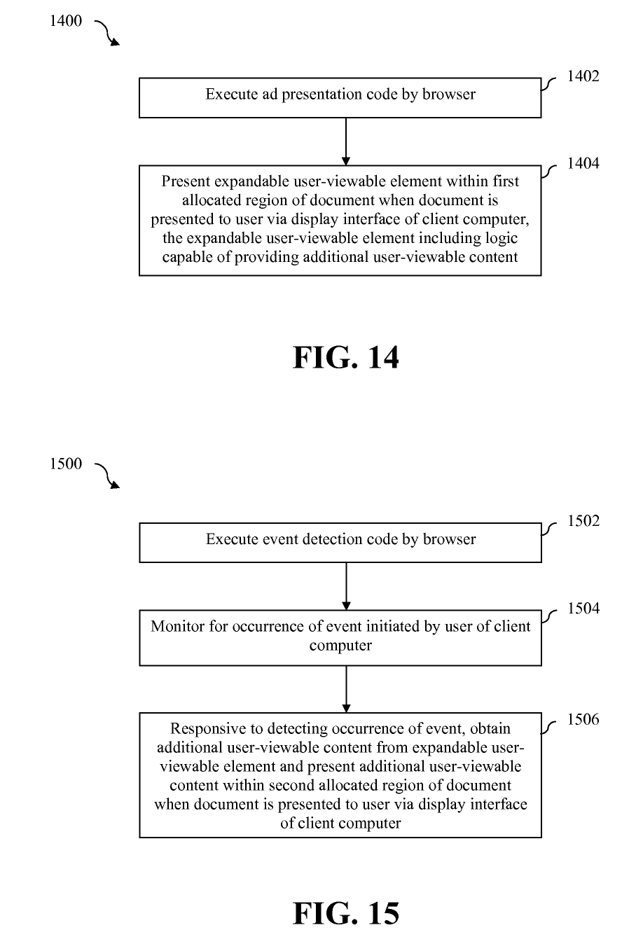

As shown in steps 1402 and 1404 of flowchart 1400 of FIG. 14, the ad presentation code is configured such that, when it is executed by document browser 112 loaded on client computer 102 (which may comprise, for example, a Web browser), it causes an expandable-user viewable element to be presented within a first allocated region of the document when the document is presented to the user via display 152 of client computer 102. As discussed elsewhere herein, the expandable user-viewable element includes logic that is capable of providing additional user-viewable content. In an embodiment, the expandable user-viewable element comprises an expandable online ad.

As shown in steps 1502, 1504 and 1506 of flowchart 1500, the event detection logic is configured such that, when it is executed by document browser 112 loaded on client computer 102, it monitors for the occurrence of event initiated by user of client computer 102 and, responsive to detecting an occurrence of the event, it obtains the additional user-viewable content from the expandable user-viewable element and presents the additional user-viewable content within a second allocated region of the document when the document is presented to the user via display 152 of client computer 102. In an embodiment, detecting the occurrence of the event comprises detecting that the user has hovered the pointer over the first allocated region of the document.

As also discussed elsewhere herein, the ad presentation code may be configured such that, when it is executed by document browser 112 loaded on client computer 102, it causes a plurality of expandable-user viewable elements to be presented within unique corresponding regions of the document when the document is presented to the user via display 152 of client computer 102. In accordance with such an embodiment, the event detection code may be configured such that, when it is executed by document browser 112 loaded on client computer 102, it monitors for a user interaction with any of the expandable user-viewable elements and, responsive to detecting a user interaction with a particular one of the expandable user-viewable elements, it obtains the corresponding additional user-viewable content from the particular one of the expandable user-viewable elements and presents the obtained additional user-viewable content within at least one allocated region of the document when the document is presented to the user via display 152 of client computer 102.

### V. Example Computer System Implementation

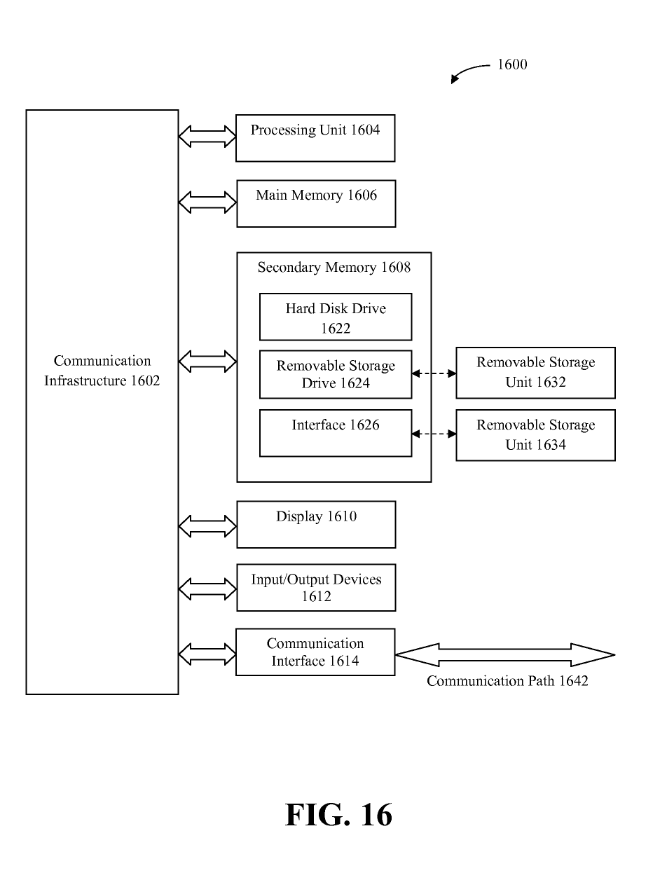

Embodiments of the present invention described herein, including systems, methods/processes, and/or apparatuses, may be implemented using one or more processor-based computer systems, such as computer system 1600 shown in FIG. 16. For example, client computer 102 may be implemented using computer system 1600 while document serving system 104, ad serving system 106, document publisher system 1102 and/or ad development environment 1104 may each be implemented using one or more computer systems 1600. Furthermore, any of the methods depicted in flowcharts 1200, 1300, 1400 and 1500 of FIGS. 12, 13, 14 and 15, respectively, may be implemented using one or more computer systems 1600.

As shown in FIG. 16, computer system 1600 includes a processing unit 1604 that includes one or more processors or processor cores. Processor unit 1604 is connected to a communication infrastructure 1602, which may comprise, for example, a bus or a network.

Computer system 1600 also includes a main memory 1606, preferably random access memory (RAM), and may also include a secondary memory 1608. Secondary memory 1608 may include, for example, a hard disk drive 1622 and/or a removable storage drive 1624. Removable storage drive 1624 may comprise a floppy disk drive, a magnetic tape drive, an optical disk drive, a tape backup, or the like. Removable storage drive 1624 reads from and/or writes to a removable storage unit 1632 in a well-known manner. Removable storage unit 1632 may comprise a floppy disk, magnetic tape, optical disk, or the like, which is read by and written to by removable storage drive 1624. As will be appreciated by persons skilled in the relevant art(s), removable storage unit 1632 includes a computer-readable storage medium having stored therein computer software and/or data.

In alternative implementations, secondary memory 1608 may include other similar means for allowing computer programs or other instructions to be loaded into computer system 1600. Such means may include, for example, a removable storage unit 1634 and an interface 1626. Examples of such means may include a memory stick and an industry standard interface (such as a universal serial bus (USB) interface) suitable for interfacing with the memory stick, a memory card and associated card reader, a removable memory chip (such as an EPROM or PROM) and associated socket, a program cartridge and cartridge interface (such as that found in video game devices), and other removable storage units 1634 and interfaces 1626 that allow software and data to be transferred from removable storage unit 1634 to computer system 1600.

Computer system 1600 may further include a display 1610 for presenting user-viewable content rendered by processing unit 1604 and/or optional display interface hardware (not shown in FIG. 16) as well as one or more input/output (I/O) devices 1612 for receiving input from or producing output to a user. Exemplary input devices include a keyboard, mouse, keypad, touch screen, or the like. Exemplary output devices include audio devices such as speakers. Display 1610 may also be considered an output device.

Computer system 1600 may also include a communication interface 1614. Communication interface 1614 allows software and data to be transferred between computer system 1600 and external devices. Examples of communication interface 1614 may include a modem, a network interface (such as an Ethernet card), a communications port, a PCMCIA slot and card, or the like. Software and data transferred via communication interface 1614 are in the form of signals which may be electronic, electromagnetic, optical, or other signals capable of being received by communication interface 1614. These signals are provided to communication interface 1614 via a communication path 1642. Communications path 1642 carries signals and may be implemented using wired communication media such as a phone line, coaxial cable or fiber optic cable, as well as wireless communication media such as radio frequency (RF) or infrared communication channels.

As used herein, the terms “computer program medium” and “computer readable medium” are used to generally refer to media such as removable storage unit 1632, removable storage unit 1634 and a hard disk installed in hard disk drive 1622. Computer program medium and computer readable medium can also refer to memories, such as main memory 1606 and secondary memory 1608, which can be semiconductor devices (e.g., DRAMs, etc.). These computer program products are means for providing software to computer system 1600.

Computer programs (also called computer control logic, programming logic, or logic) are stored in main memory 1606 and/or secondary memory 1608. Computer programs may also be received via communication interface 1614. Such computer programs, when executed, enable computer system 1600 to implement features of the present invention as discussed herein. Accordingly, such computer programs represent controllers of the computer system 1600. Where the invention is implemented using software, the software may be stored in a computer program product and loaded into computer system 1600 using removable storage drive 1624, interface 1626, or communication interface 1614.

The invention is also directed to computer program products comprising software stored on any computer readable medium. Such software, when executed in one or more data processing devices, causes a data processing device(s) to operate as described herein. Embodiments of the present invention employ any computer readable medium, known now or in the future. Examples of computer readable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for serving a user-viewable document to a user over a network in a manner that facilitates the presentation of at least one expandable user-viewable element within the document, comprising:
assembling the document, wherein assembling the document comprises
including ad presentation code within the document that, when executed by a client computer, causes a first expandable user-viewable element to be presented within a first allocated region of the document when the document is presented to the user via a display of the client computer, the first expandable user-viewable element including logic capable of providing first additional user-viewable content,
including event detection code within the document that, when executed by the client computer, monitors for an occurrence of a first event initiated by the user of the client computer and that, responsive to detecting the occurrence of the first event, obtains the first additional user-viewable content from the first expandable user-viewable element and presents the first additional user-viewable content within a second allocated region of the document when the document is presented to the user via the display of the client computer; and
serving the assembled document to the user over the network.

2. The method of claim 1, wherein the logic capable of providing first additional user-viewable content is configured to obtain the first additional user-viewable content from within the first expandable user-viewable element.

3. The method of claim 1, wherein the logic capable of providing first additional user-viewable content is configured to obtain the first additional user-viewable content from a remote network entity.

4. The method of claim 1, wherein the user-viewable document comprises a Web page and the client computer comprises a Web browser configured to execute at least the ad presentation code and the event detection code.

5. The method of claim 1, wherein the first expandable user-viewable element comprises an advertisement.

6. The method of claim 1, wherein including the ad presentation code within the document comprises including the first expandable user-viewable element within the document.

7. The method of claim 1, wherein including the ad presentation code within the document comprises including code that, when executed by a client computer, obtains the first expandable user-viewable element from a server over the network.

8. The method of claim 1, wherein the first expandable user-viewable element comprises a movie and wherein the logic capable of providing the first additional user-viewable content includes a secure component used to obtain the first additional user-viewable content from a developer of the movie.

9. The method of claim 1, wherein including the event detection code within the document comprises including code that, when executed by the client computer, monitors to determine if the user has hovered a pointer over the first allocated region of the document and that, responsive to detecting that the user has hovered the pointer over the first allocated region of the document, obtains the first additional user-viewable content from the first expandable user-viewable element and presents the first additional user-viewable content within the second allocated region of the document when the document is presented to the user via the display of the client computer.

10. The method of claim 1, wherein including the ad presentation code within the document further comprises including code that, when executed by the client computer, causes a second expandable user-viewable element to be presented within a third allocated region of the document when the document is presented to the user via the display of the client computer, the second expandable user-viewable element including logic capable of providing second additional user-viewable content, and
wherein including the event detection code within the document further comprises including code that, when executed by the client computer, monitors for an occurrence of a second event initiated by the user of the client computer and that, responsive to detecting the occurrence of the second event, obtains the second additional user-viewable content from the second expandable user-viewable element and presents the second additional user-viewable content within the second allocated region of the document when the document is presented to the user via the display of the client computer.

11. The method of claim 1, wherein including the ad presentation code within the document further comprises including code that, when executed by the client computer, causes a second expandable user-viewable element to be presented within a third allocated region of the document when the document is presented to the user via the display of the client computer, the second expandable user-viewable element including logic capable of providing second additional user-viewable content, and
wherein including the event detection code within the document further comprises including code that, when executed by the client computer, monitors for an occurrence of a second event initiated by the user of the client computer and that, responsive to detecting the occurrence of the second event, obtains the second additional user-viewable content from the second expandable user-viewable element and presents the second additional user-viewable content within a fourth allocated region of the document when the document is presented to the user via the display of the client computer.

12. A system configured to serve a user-viewable document to a user over a network in a manner that facilitates the presentation of at least one expandable user-viewable element within the document, comprising:
a document assembler configured to assemble the document by including ad presentation code within the document that, when executed by a client computer, causes a first expandable user-viewable element to be presented within a first allocated region of the document when the document is presented to the user via a display of the client computer, the first expandable user-viewable element including logic capable of providing first additional user-viewable content and by including event detection code within the document that, when executed by the client computer, monitors for an occurrence of a first event initiated by the user of the client computer and that, responsive to detecting the occurrence of the first event, obtains the first additional user-viewable content from the first expandable user-viewable element and presents the first additional user-viewable content within a second allocated region of the document when the document is presented to the user via the display of the client computer; and
a document server that is configured to serve the assembled document to the user over the network.

13. The system of claim 12, wherein the user-viewable document comprises a Web page and the client computer comprises a Web browser configured to execute at least the first and second code.

14. The system of claim 12, wherein the first expandable user-viewable element comprises an advertisement.

15. The system of claim 12, wherein the document assembler is configured to include the ad presentation code within the document by including the first expandable user-viewable element within the document.

16. The system of claim 12, wherein the document assembler is configured to include the ad presentation code within the document by including code that, when executed by a client computer, obtains the first expandable user-viewable element from a server over the network.

17. The system of claim 12, wherein the first expandable user-viewable element comprises a movie and wherein the logic capable of providing the first additional user-viewable content includes a secure component used to obtain the first additional user-viewable content from a developer of the movie.

18. The system of claim 12, wherein the document assembler is configured to include the event detection code within the document by including code that, when executed by the client computer, monitors to determine if the user has hovered a pointer over the first allocated region of the document and that, responsive to detecting that the user has hovered the pointer over the first allocated region of the document, obtains the first additional user-viewable content from the first expandable user-viewable element and presents the first additional user-viewable content within the second allocated region of the document when the document is presented to the user via the display of the client computer.

19. The system of claim 12, wherein the document assembler is further configured to include the ad presentation code within the document by including code that, when executed by the client computer, causes a second expandable user-viewable element to be presented within a third allocated region of the document when the document is presented to the user via the display of the client computer, the second expandable user-viewable element including logic capable of providing second additional user-viewable content, and
wherein the document assembler is further configured to include the event detection code within the document by including code that, when executed by the client computer, monitors for an occurrence of a second event initiated by the user of the client computer and that, responsive to detecting the occurrence of the second event, obtains the second additional user-viewable content from the second expandable user-viewable element and presents the second additional user-viewable content within the second allocated region of the document when the document is presented to the user via the display of the client computer.

20. The system of claim 12, wherein the document assembler is further configured to include the ad presentation code within the document by including code that, when executed by the client computer, causes a second expandable user-viewable element to be presented within a third allocated region of the document when the document is presented to the user via the display of the client computer, the second expandable user-viewable element including logic capable of providing second additional user-viewable content, and
wherein the document assembler is further configured to include the event detection code within the document by including code that, when executed by the client computer, monitors for an occurrence of a second event initiated by the user of the client computer and that, responsive to detecting the occurrence of the second event, obtains the second additional user-viewable content from the second expandable user-viewable element and presents the second additional user-viewable content within a fourth allocated region of the document when the document is presented to the user via the display of the client computer.

21. A method for serving a Web page to a user over a network in a manner that facilitates the presentation of multiple expandable user-viewable elements within the Web page, comprising:
assembling the Web page, wherein assembling the Web page comprises
including first logic within the Web page that, when executed by a client computer, causes a plurality of expandable user-viewable elements to be presented within unique corresponding regions of the Web page when the Web page is presented to the user via a display of the client computer, each of the plurality of expandable user-viewable elements including logic capable of providing corresponding additional user-viewable content,
including second logic within the Web page that, when executed by the client computer, monitors for a user interaction with any of the expandable user-viewable elements and that, responsive to detecting a user interaction with a particular one of the expandable user-viewable elements, obtains the corresponding additional user-viewable content from the particular one of the expandable user-viewable elements and presents the obtained additional user-viewable content within at least one allocated region of the Web page when the Web page is presented to the user via the display of the client computer; and
serving the assembled Web page to the user over the network.

22. The method of claim 21, wherein including the second logic within the Web page comprises including logic that, when executed by the client computer, monitors to determine if the user has hovered a pointer over any of the expandable user-viewable elements and that, responsive to detecting that the user has hovered the pointer over a particular one of the expandable user-viewable elements, obtains the corresponding additional user-viewable content from the particular one of the expandable user-viewable elements and presents the obtained additional user-viewable content within the at least one allocated region of the Web page when the Web page is presented to the user via the display of the client computer.
